(19) United States
(12) Patent Application Publication
(10) Pub. No.: US 2001/0042020 A1
(43) Pub. Date: Nov. 15, 2001

(54) METHOD FOR INCREASING ELECTRONIC BUSINESS

(76) Inventors: DAVID SCHACHNE, WESTPORT, CT (US); JAY SUNG, NEW YORK, NY (US)

Correspondence Address: TESTA, HURWITZ & THIBEAULT, LLP, HIGH STREET TOWER, 125 HIGH STREET, BOSTON, MA, 02110, US

(21) Appl. No.: 09/207,210

(22) Filed: Dec. 8, 1998

(51) Int. Cl. G06F 17/60

(52) U.S. Cl. 705/26; 705/27

(57) ABSTRACT

A method for conducting an electronic business transaction with a customer over a network is described. A first computer system is in communication with a second computer system via the network. The first computer system stores product information of a business association. A customer using the second computer system can browse the product information by downloading the information from the first computer system to the second computer system. The customer submits sufficient information to conduct a first potential business transaction in order to obtain at least one of the business offerings. After obtaining the sufficient information from the customer and determining that the customer intends to conclude the first potential business transaction, an offer to conduct a second, different potential business transaction is presented to the customer. The second, different potential business transaction is concluded without requiring the customer to submit any additional information other than that the customer accepts the offer.

### FIELD OF THE INVENTION

The invention relates generally to a method for conducting electronic business transactions over a network. More specifically, the invention relates to a method for multiplying transactional opportunities from an existing business transaction between businesses and their customers.

### BACKGROUND

With the advent of the international network known as the Internet or the World Wide Web, currently providing connectivity among over a 100 million users, opportunities abound for businesses to reach potential customers with offers of products and services. Many businesses have capitalized upon this expansive reach by advertising and selling products and services to customers over the network. To advertise and sell their wares, such businesses have developed “web pages.” Typically, a service provider can store the web pages on a server (i.e., a web-site) connected to the network. With the use of browser software installed on their computer systems, potential customers can readily visit web sites, explore web pages, and engage in business transactions.

Browsing web sites and web pages can be at times confusing. A typical web page includes multiple links to other web pages. These, in turn, point to even more web pages. Conceivably, as the customer traverses several levels and sub-levels of web pages, business items offered by the business may be overlooked or missed altogether. Opportunities to sell such items may be lost.

Moreover, typically when a customer decides to enter into a business transaction, the business requires that the customer provide personal and billing information so that the business can obtain payment. The process of filling out an on-line purchase order form, however, may be a tedious, time-consuming task for the customer, a process that might even discourage sales. Some businesses have sought to minimize this burden by allowing a customer to fill a “shopping cart” with selected items before having to submit the billing information. Still, once the customer fills out and submits the purchase order, the customer typically becomes less inclined to make additional purchases.

### SUMMARY

In one aspect, the invention features a method for conducting an electronic business transaction with a customer over a network. A first computer system is in communication with a second computer system via the network. The network can be the Internet. Digital information representing business offerings is stored in a record on the first computer system. A copy of the record is transmitted from the first computer system to the second computer system to enable the customer to browse the business offerings. Sufficient information is obtained from the customer to conduct a first potential business transaction for the customer to obtain at least one of the business offerings. An offer to conduct a second, different potential business transaction is presented to the customer after obtaining the sufficient information from the customer and determining that the customer intends to conclude the first potential business transaction. The second, different potential business transaction is concluded without requiring the customer to submit any additional information other than that the customer accepts the offer. An advantage for not requiring further input from the customer may be to entice the customer to accept the offer due to the simplicity of the operation, and thereby increase business.

The offer can be presented to the customer by a graphical pop-up window on a screen of the second computer system or on a new screen display. The offer may include subject matter related to subject matter of the first potential business transaction. The second, different potential business transaction can be for the customer to purchase a business offering or to provide the customer with a gift. An advantage gained by presenting the offer is to produce one more opportunity to secure a sale.

### BRIEF DESCRIPTION OF THE DRAWINGS

The invention is pointed out with particularity in the appended claims. The above and further advantages of the invention may be better understood by referring to the following description in conjunction with the accompanying drawings, in which:

FIG. 1 is a diagram of an embodiment of a computer system in communication with a server system for conducting electronic business transactions over a network in accordance with the invention;

FIG. 2 is an exemplary representation on the computer system of a displayed web page downloaded from the server and presenting an order form to be filled in by a potential customer to conduct a first business transaction;

FIG. 3 is a flowchart representation of an embodiment of a process by which an offer is presented to the potential customer to enter a second business transaction without requiring the customer to provide any additional information other than that the customer accepts the offer; and

FIG. 4 is an exemplary representation of a pop-up window displayed on the computer system and used to present the offer.

### DESCRIPTION OF THE INVENTION

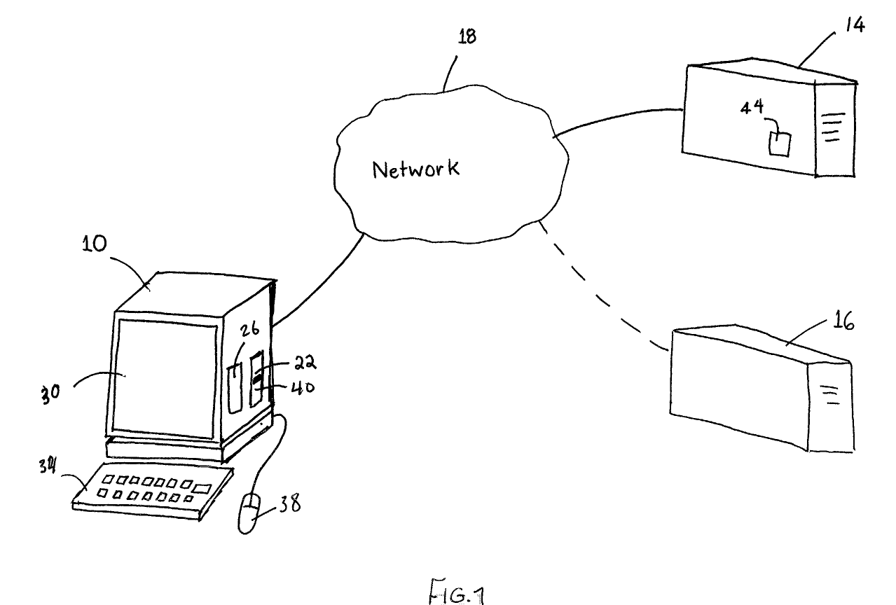

FIG. 1 shows a computer system 10 in communication with a server system 14 for conducting electronic business transactions over a network 18 in accordance with the invention. The network 18 can be a large international network (e.g., the Internet or the World Wide Web) or a small local area network (LAN) that includes a plurality of other computer and server systems (i.e., web sites). Many web sites maintain information including text files, graphics files, and executable scripts (e.g., applets) that can be collectively stored as “Web pages.” Each Web page provides a graphical representation of text and images designed by the designer of that Web page. Some of the other systems on the network 18 can be gateway computers (not shown), maintained by an Internet service provider, e.g., Earthlink, which provides access to the information on the other web sites and, in particular, to the server system 14.

The computer system 10 may be any conventional personal computer, workstation, or network terminal and may include a processor 22, memory 26 for storing data and software programs, a display screen 30, a keyboard 34, and a mouse 38. The computer system 10 can also include a modem 40 for communicating with one of the gateway computers on the network 18. One of the software programs stored in the memory 26 of the computer system 10 is browser software, e.g., Netscape Navigator™ or Microsoft Internet Explorer™. When executed, the browser software can download a web page across the network 18 from the server system 14 to the computer system 10, which translates the downloaded text files with any accompanying graphics files and applets and displays the results on the screen 30.

In one embodiment, the server system 14 is a conventional computer system operating as a web site and includes memory 44 for storing web pages. The server system 14 also includes communications capabilities for receiving requests to access the stored web pages and for transmitting the information related to the accessed web page to the requesting computer system. An ISP or a business association can maintain and operate the server system 14.

In this embodiment, the web pages stored on the server system 14 include a plurality of web pages designed by a business association that advertise business offerings (e.g., products and services) of the business association. Some of these web pages are designed to conduct business transactions so that potential customers using remote computer systems, such as the computer system 10, can access these web pages, browse the business offerings, and submit purchase orders across the network 18. A business transaction includes taking by sale, lease, premium, gift, or any other voluntary transaction between a potential customer and a business association that gives the customer an interest in a business offering of the business association.

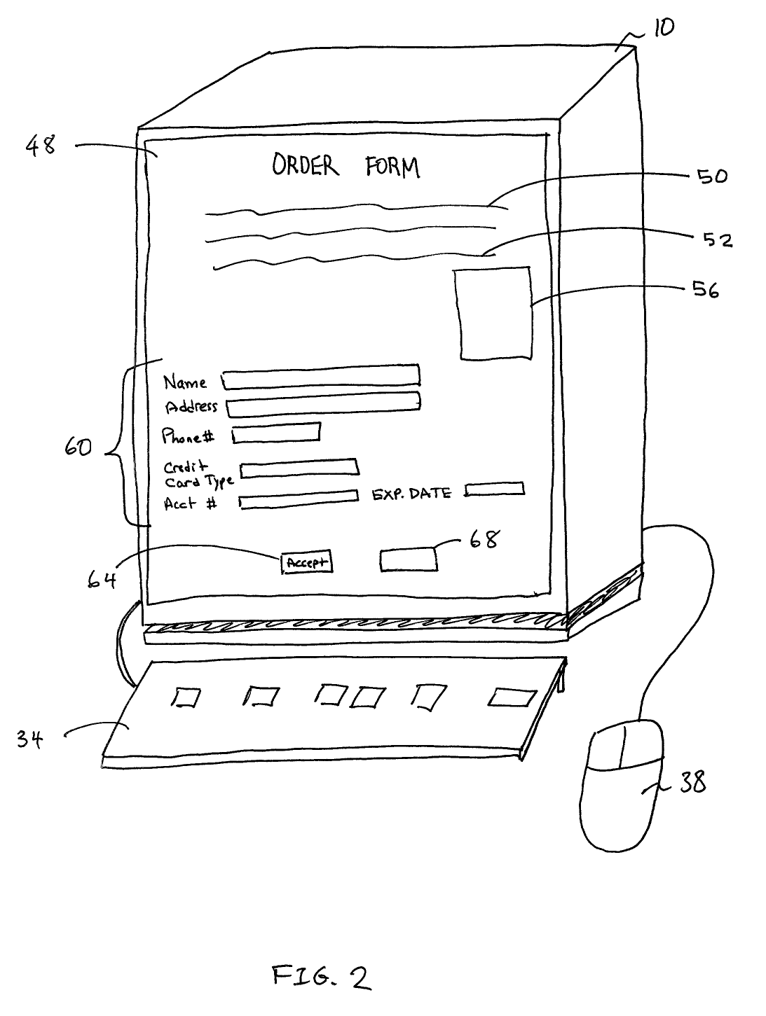

FIG. 2 shows a computer system 10 displaying the results of downloading an exemplary web page 48 of the business association from the server system 14. A user of the computer system 10 (hereafter customer) accesses the web page 48 in order to enter a business transaction with the business association (hereafter seller) to obtain one or more business offerings advertised by the seller. The web page 48 may include an order form for conducting the business transaction. The order form can also include instructions 50 on filling out the form, a description 52 of each business offering being ordered, and a graphical image 56 of that business offering.

The order form may include a customer information section 60 by which the business association requests entry by the customer of customer-related information. The requested customer information can include personal data, such as name, address, and telephone number of the customer, and billing information such as credit card type, account number, and expiration date. The order form may also include one graphical button 64 for submitting the requested customer information, and thereby conducting the business transaction, and another graphical button 68 for canceling the order form without conducting the business transaction. The customer can choose the button using the mouse 38 or the keyboard 34.

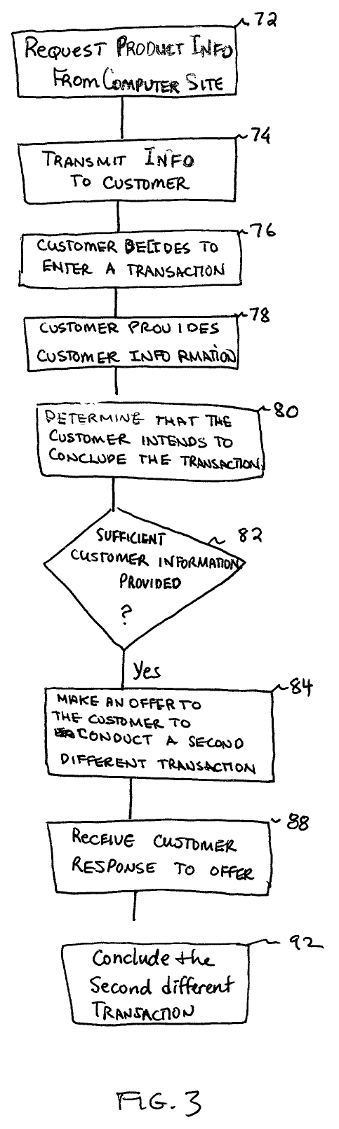

FIG. 3 shows a flow chart describing an exemplary process for increasing electronic business according to the principles of the invention. To initiate a business transaction over the network 18, the customer using the computer system 10 requests access to a web page of the seller stored on the server system 14 (step 72). In response to this request, the server system 14 transmits the requested web page to the computer system 10 (step 74). That web page is displayed on the computer system screen 30. This web page can catalog current and future products and/or services of the seller and provide links to other web pages containing more information about such business offerings. These other web pages may be stored on the server system 14 or at another server system 16 (shown in FIG. 1) in the network 18.

The customer can browse the business offerings of the seller and, if interested, select one or more of the products and or services for purchase (step 76). When the customer has completed selecting products for purchase, the customer can conduct a business transaction with the seller by accessing a web page with an order form, e.g., the order form of FIG. 2. The order form requires that the customer enter sufficient customer information for the business transaction to transpire (step 78). What qualifies as sufficient information can vary. For customers that have had previous business dealings with the seller, providing only the name may suffice because the necessary information is already possessed by the seller. For new customers, however, all of the personal data and billing information may be necessary.

Upon entering the required customer information, the customer can click with the mouse the graphical button 64 that submits the business transaction to the seller. Alternatively, the customer can decide not to make the purchase and click the graphical button 68 that cancels the business transaction. A variety of other actions by the customer can cancel the business transaction (e.g., the customer can visit a different web site, close the window displaying the order form, or terminate the browser.) At the moment when the customer chooses to cancel, the customer may or may not have entered sufficient information to conduct the business transaction. Whether by submitting or by canceling the business transaction, the customer has indicated an intent to conclude the business transaction, and the provided customer information can be stored in memory, either at the computer system 10 or transmitted to and stored on the server system 14.

A software program, executing on the server system 14 or on the computer system 10 as part of the browser software or as an applet downloaded with a web page, determines the intention of the customer to conclude the business transaction (step 80). Upon this determination and if the customer has provided sufficient information to conduct the business transaction, an offer is presented to the customer to enter a second business transaction different from the previous business transaction (step 84). The offer can be presented by a pop-up window on the screen 30 of the computer system 10 or by a new display screen. Other multimedia techniques for conveying the offer to the customer are contemplated, including the use of audio and video sequences.

The digital information that produces the offer on the screen 30 can be transmitted to the computer system 10 from the server system 14 or from another server system 16 on the network 18. This digital information can be transmitted to the computer system 10 when the customer acquires the order form or after the software program determines that the customer intends to conclude the previous business transaction.

Presenting this offer at the moment the customer intends to conclude the previous business transaction generates one more opportunity for the seller to gain a sale from the customer, particularly if the offer brings to the attention of the customer an item of potential or known interest that may have been overlooked. In one embodiment, the offer can involve subject matter that is related to subject matter of the previous business transaction. For example, if the previous business transaction is a purchase of a certain book, then the second, different business transaction can be for the purchase of another book by the same author or on the same topic. In another embodiment, the subject matter of the offer can be unrelated to the subject matter of the previous business transaction. A different business association than the business association of the previous business transaction may be presenting the offer.

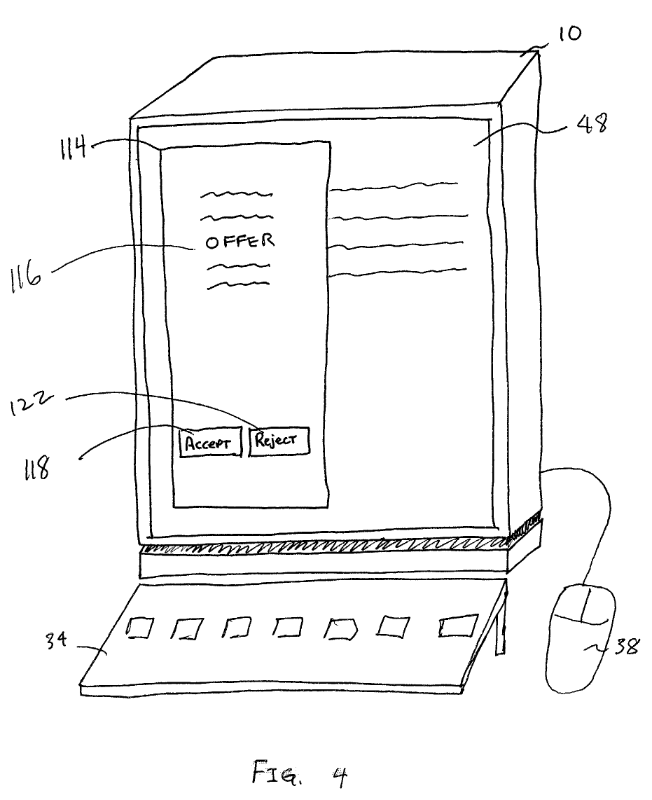

FIG. 4 shows an exemplary pop-up window 114 containing the offer 116 superimposed on the order form 48. The offer 116 can include a graphical button 118 for accepting the offer and another graphical button 122 for rejecting the offer. In another embodiment, the offer 116 can be displayed on a new screen display.

Referring again to FIG. 3, when the customer accepts the offer, this concludes the second business transaction without requiring the customer to submit additional customer information or reply to any queries or make any other selections or responses (step 88). The computer system 10 signals the server system 14 of the acceptance, and transmits the customer information, if not previously transmitted. The server system 14 uses the sufficient information provided by the customer for the previous business transaction to conclude the second transaction (step 92). If the offer originated from a server system other than the server system 14, then the computer system 10 can communicate the acceptance of the customer and the customer information with that other server system 16, directly or via the server system 14, and that other server system 16 can use the customer information to conclude the second business transaction.

Because this process requires no further action from the customer to complete the proposed second business transaction, the relative ease of conducting business transactions may entice the customer to accept the offer, and consequently stimulates business. Moreover, the process of the invention can stimulate more additional business transactions by presenting new offers and concluding additional business transactions as described above for as often as the customer accepts each new offer.

While the invention has been shown and described with reference to specific preferred embodiments, it should be understood by those skilled in the art that various changes in form and detail may be made therein without departing from the spirit and scope of the invention as defined by the following claims.

We claim:

1. A method for conducting an electronic business transaction with a customer over a network, comprising the steps of:
providing a first computer system in communication with a second computer system via the network;
storing in a record on the first computer system digital information representing a plurality of business offerings;
transmitting a copy of the record from the first computer system to the second computer system to enable the customer to view the business offerings;
obtaining from the customer sufficient information to conduct a first potential business transaction for the customer to obtain at least one of the business offerings;
presenting the customer an offer to conduct a second, different potential business transaction after obtaining the sufficient information from the customer and determining that the customer intends to conclude the first potential business transaction; and
concluding the second, different potential business transaction without the customer entering any additional information other than that the customer accepts the offer.

2. The method of claim 1 wherein the network is the Internet.

3. The method of claim 1 further comprising the step of transmitting digital information to the second computer system that presents the offer by a graphical pop-up window on a screen of the second computer system.

4. The method of claim 3 wherein the step of transmitting digital information that presents the offer is performed by a third computer system.

5. The method of claim 1 further comprising the step of transmitting digital information to the second computer system that presents the offer on a new screen display on the second computer system.

6. The method of claim 1 wherein the offer includes subject matter related to subject matter of the first potential business transaction.

7. The method of claim 1 further comprising the step of receiving the sufficient information at the first computer system after determining that the customer intends to conclude the first potential business transaction and before the customer concludes the second potential business transaction by accepting the offer.

8. The method of claim 1 further comprising the step of receiving the sufficient information at the first computer system after the customer concludes the second potential business transaction by accepting the offer.

9. The method of claim 1 wherein the second, different potential business transaction is for the customer to purchase a business offering.

10. The method of claim 1 further comprising the step of providing a software program for determining that the customer intends to conclude the first potential business transaction.

11. The method of claim 10 wherein the software program executes on the first computer system.

12. The method of claim 10 further comprising the step of transmitting the software program from the first computer system to the second computer system for execution on the second computer system.

13. The method of claim 1 further comprising the step of determining that the customer intends to conclude the first potential business transaction when the customer submits the sufficient information.

14. The method of claim 1 further comprising the step of determining that the customer intends to conclude the first potential business transaction when the customer cancels the first potential business transaction.

15. The method of claim 1 wherein the offer is a first offer and further comprising the steps of:
presenting the customer a new offer to conduct a new, different potential business transaction when the customer accepts the first offer; and
concluding the new, different potential business transaction without requiring the customer to enter any additional information other than that customer accepts the new offer.

16. The method of claim 15 further comprising the steps of presenting a new offer and concluding a new, different business transaction for as often as the customer accepts the new offer.

17. A method for conducting an electronic business transaction with a customer over a network, comprising the steps of:
providing web pages on a first computer system on the network, the web pages enabling the customer to view a plurality of business offerings when the customer accesses one of the web pages;
obtaining from the customer via the network sufficient information to conduct a first potential business transaction for the customer to obtain at least one of the business offerings;
presenting the customer via the network an offer to conduct a second, different potential business transaction after obtaining the sufficient information from the customer and determining that the customer intends to conclude the first potential business transaction; and
concluding the second, different potential business transaction without the customer entering any additional information other than that the customer accepts the offer.

18. A computer system connected to a network, comprising:
memory storing digital information representing a plurality of business offerings;
a first computer in communication with the memory and transmitting the digital information to a second computer system to enable a user of the second computer system to view the business offerings;
computer-readable software for obtaining from the user sufficient information to conduct a first potential business transaction for the user to obtain at least one of the business offerings;
computer-readable software for presenting the user an offer to conduct a second, different potential business transaction after obtaining the sufficient information from the user and determining that the user intends to conclude the first potential business transaction; and
computer-readable software for concluding the second, different potential business transaction without the user entering any additional information other than that the user accepts the offer.

19. The computer system of claim 18 wherein the computer-readable software for presenting the user an offer produces a graphical pop-up window on a screen of the second computer system.

20. The computer system of claim 18 further comprising a third computer system connected to the network, the third computer system providing the computer-readable software for presenting the user an offer.
